(19) United States
(12) Patent Application Publication
(10) Pub. No.: US 2003/0147417 A1
(43) Pub. Date: Aug. 7, 2003

(54) System and method for providing internet service from non-IP based network to internet

(76) Inventor: Sang Seo, Seoul (KR)

Correspondence Address: BIRCH STEWART KOLASCH & BIRCH, PO BOX 747, FALLS CHURCH, VA, 22040-0747, US

(21) Appl. No.: 09/891,359

(22) Filed: Jun. 27, 2001

(30) Foreign Application Priority Data
Jun. 5, 2000 (KR) 30817/2000

(51) Int. Cl. H04L 12/56

(52) U.S. Cl. 370/466; 370/477

(57) ABSTRACT

A system for providing an Internet service in a non-IP based network, includes a first server connected to a non-IP based network and having an application program as installed; and a second server connected to a non-IP based network and an IP based network (the Internet) and having the application program as installed, so that a service corresponding to an Internet service request is provided to the Internet according to the Internet service request received from the Internet. When the Internet server proxy connected to the Internet receives an Internet service request from the Internet and transmits the Internet service request to a corresponding Internet service server connected as being distributed in the digital network, the Internet service server provides the Internet service to the Internet through the Internet server proxy, so that the appliances can be controlled through the Internet. In addition, since the Internet service servers connected through the digital network and the Internet service server proxy connected to the Internet have the same protocol layer, so that the type of the service and information can be shared by them and its application program can be easily fabricated.

### BACKGROUND OF THE INVENTION

1. Field of the Invention

The present invention relates to a system and method for rendering appliances connected through a home network to be connected to the Internet for an Internet communication, and more particularly, to a system and method for rendering appliances connected to a non-Internet protocol (IP) based network to be connected to the Internet and providing Internet services thereto.

2. Description of the Background Art

FIG. 1 is a schematic view showing the construction of a digital network connected to the Internet in accordance with a conventional art.

As shown in FIG. 1, a set-top box 10 connected to the Internet, a digital television (DTV) 11 connected through an IEEE 1394 serial bus line to the set-top box 10 and a digital VCR (DVCR) 12 are connected to each other.

The network shown in FIG. 1 is a digital network constructed in the home. The electric home appliances forming the digital network should have a regular communication standard for data communication through the Internet.

That is, the set-top box 10, the digital television 11 and the digital VCR 12 includes a data processing stack for transmitting and receiving a data through the Internet, a control stack for controlling transmission, and an application program.

The data processing stack includes an IEEE 1394 protocol layer forming a digital network between the electric home appliances, a TCP/IP protocol layer for transmitting and receiving a data through the Internet and an IP over 1394 layer for connecting the TCP/IP protocol layer and the IEEE 1394 protocol layer.

The control stack includes a HAVi (Home Audio/Video interoperability) protocol layer for controlling an audio and a video signal in the home and an IEC 61883 protocol layer for connecting the HAVi protocol layer and the IEEE 1394 protocol layer.

Accordingly, one of the home appliances, for example, a set-top box, further includes an Internet interface protocol layer in addition to the protocol layer included in the digital television or the digital VCR, through which it is connected with the Internet.

Since the set-top box is connected to the Internet, the digital television and the digital VCR are connected the Internet via the set-top box.

However, the network constructed in the home in accordance with the conventional art has the following problems.

That is, the home appliances must use the TCP/IP protocol layer and the IP over 1394 protocol layer when they are desired to be connected to the Internet.

In order to use the TCP/IP protocol layer, each appliance should have its own real IP address. And in case that there is a difficulty in assigning real IP addresses as many as the home appliances, a DHCP server should be additionally implemented to assign an IP address.

In addition, the control protocols between the electronic home appliances and the protocol for providing an Internet service are completely different, it is not easy to fabricate an application program of each home appliance.

### SUMMARY OF THE INVENTION

Therefore, an object of the present invention is to provide a system and method for providing an Internet service in a non-IP based network which is capable of transmitting a service according to an Internet service request received from the Internet.

Another object of the present invention is to provide a system and method for providing an Internet service in a non-IP based network which is capable of easily fabricating and installing application programs for appliances and providing an Internet service to the appliances according to their Internet service request.

To achieve these and other advantages and in accordance with the purpose of the present invention, as embodied and broadly described herein, there is provided a system for providing an Internet service in a non-IP based network, including a first server connected to a non-IP based network and having an application program as installed; and a second server connected to a non-IP based network and an IP based network (the Internet) and having the application program as installed, so that a service corresponding to an Internet service request can be provided to the Internet according to the Internet service request received from the Internet.

To achieve the above objects, there is also provided a method for providing an Internet service in a non-IP based network, including a step in which a non-IP based network receives an Internet service request from the Internet; and a step in which the non-IP based network provides the Internet service corresponding to the received Internet service request to the Internet.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view showing the construction of a digital network connected to the Internet in accordance with a conventional art;

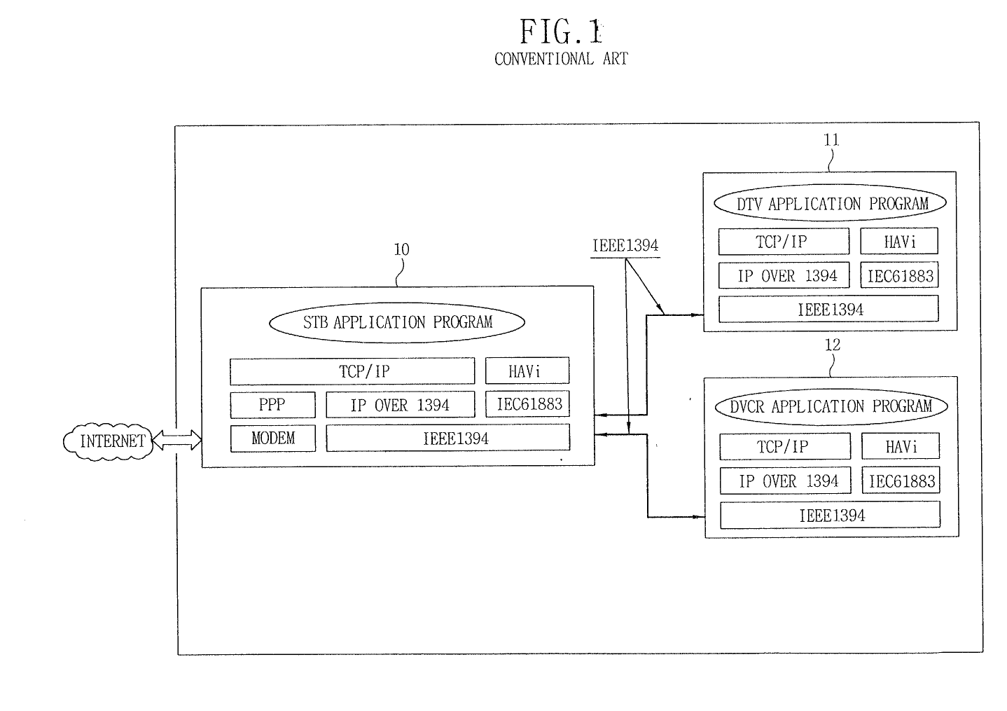

FIG. 2 is a schematic view showing the construction of a digital network for providing an Internet service in accordance with a first embodiment of the present invention;

FIG. 3 is a flow chart for providing an Internet service from the digital network to the Internet; and

FIG. 4 is a schematic view showing the construction of a HAVi network for providing the Internet service in accordance with a second embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

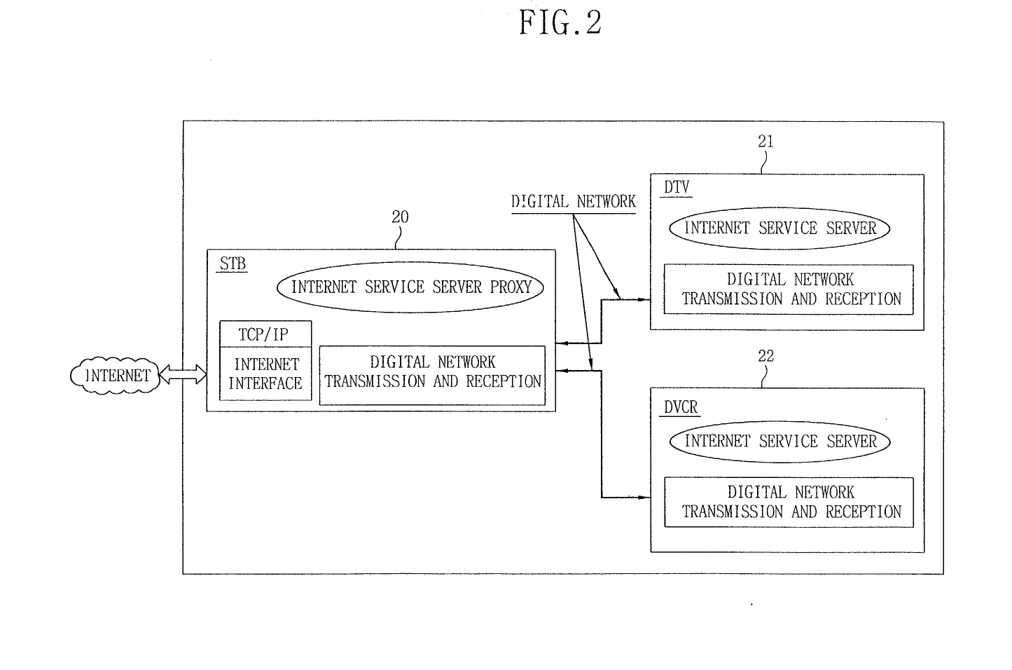

FIG. 2 is a schematic view showing the construction of a digital network for providing an Internet service in accordance with a first embodiment of the present invention.

As shown in FIG. 2, a set-top box (STB) 20 connected to the Internet, a digital television (DTV) 21 and a digital VCR (DVCR) 22 each connected to the set-top box 20 through a digital network are mutually connected.

The set-top box 20 includes an Internet service server proxy providing a service to the Internet and having a server function of other electronic home appliances connected to the digital network, a digital network transmission and reception protocol layer for transmitting and receiving a digital signal through the digital network, a TCP/IP protocol layer for processing a data so as to be transmitted through the Internet, and an Internet interface protocol layer connected to the Internet to transmit and receive a data.

The digital television 21 includes a server for providing a service to the Internet and a digital network transmission and reception protocol layer for processing a digital signal transmitted and received when the server provides the service.

The digital VCR 22, like the digital television, includes a server for providing a service to the Internet and a digital network transmission and reception protocol layer for processing a digital signal transmitted and received when the server provides the service.

As depicted, the set-top box among the appliances connected to the digital network additionally includes a protocol layer such as a TCP/IP or a PPP which allows an Internet connection device to be connected to the Internet, while, the digital television or the digital VCR merely has the Internet service server.

The Internet connection device implements an Internet service server proxy to collect information on an Internet service available Internet service server from other appliances connected through the digital network and provide the information so that the appliance of the Internet can be initially connected.

Accordingly, an appliance which has not been connected to the Internet implements an Internet service server for an Internet service through which itself can provide and implements a means through which the Internet service server provides an Internet service.

That is, the appliance connected to the Internet identifies initial connection information provided by the Internet connection device to obtain information such as an address (URL) for a desired appliance and request a service. Then, upon receipt of the service request, the Internet connection device interprets the service request and transmits it to a corresponding appliance.

Upon receipt of the Internet service request, the Internet service server transmits a response to the Internet connection device, and then, upon receipt of the response, the Internet connection device transmits the corresponding response through the Internet to the appliance which has requested it.

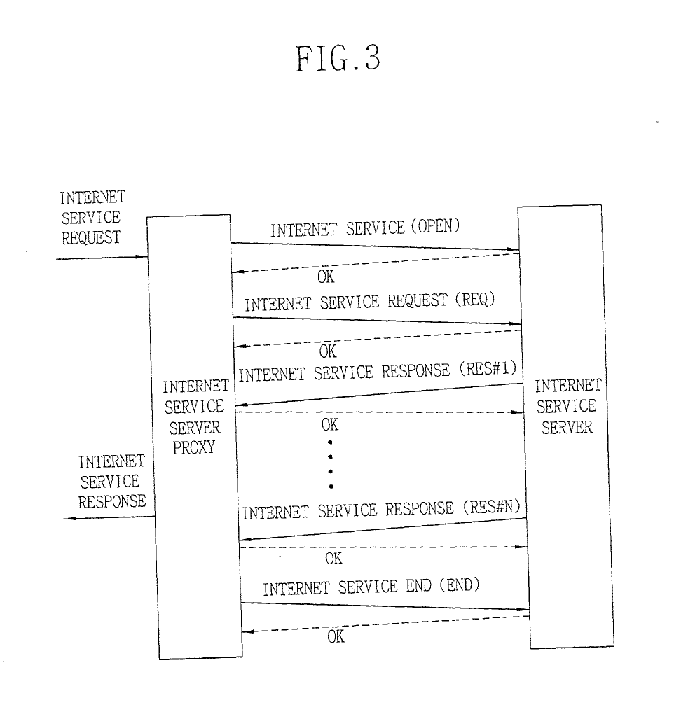

FIG. 3 is a flow chart of a method for providing an Internet service from the digital network to the Internet, showing the order in which the home appliances provide a service when the Internet requests the service from the digital network and the connected appliances.

First, when an Internet service is requested through the Internet, the Internet service server proxy determines whether the requested service is to be provided by itself or to be provided by the next Internet service server. If the service is to be provided by the Internet service server proxy, the Internet service server proxy provides the Internet service to the appliance which has requested it through the Internet.

If the service is to be provided by a different Internet service server, the Internet service server proxy transmits an Internet service start signal to the Internet service server corresponding to the request through the digital network.

Upon receipt of the Internet service start signal (OPEN), the corresponding Internet service server transmits an OK response signal to the OPEN signal to the Internet service server proxy.

Then, the Internet service server proxy transmits an Internet service request signal (REQ), and the Internet service server transmits an OK response signal in response thereto.

After the Internet service server transmits the OK response signal to the Internet service server, it provides the requested Internet service to the Internet through the Internet service server proxy.

Thereafter, the Internet service server proxy transmits an Internet service termination signal (END) to the Internet service server, the Internet service server stops operation for providing the Internet service.

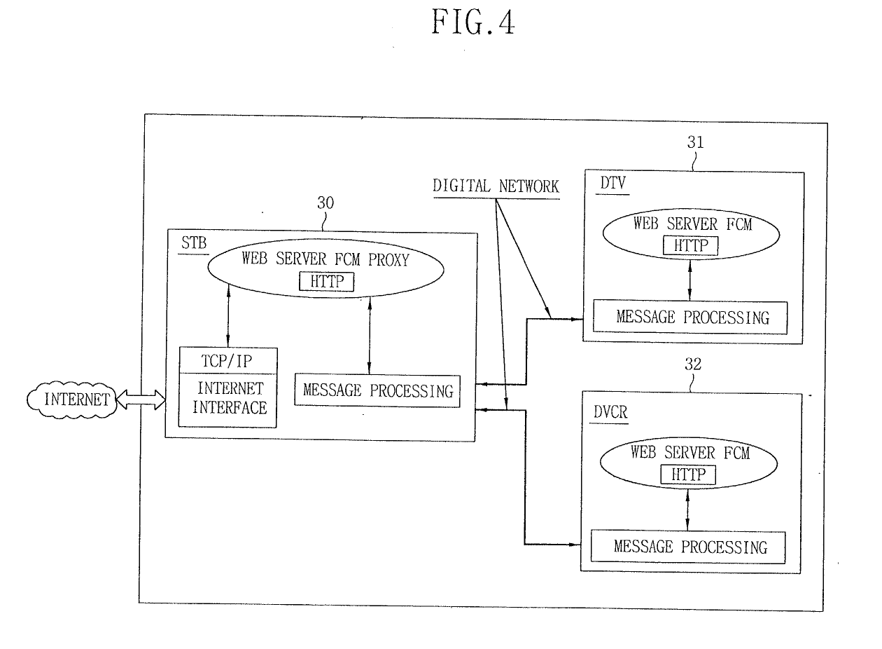

FIG. 4 is a schematic view showing the construction of a HAVi network for providing the Internet service in accordance with a second embodiment of the present invention.

As shown in FIG. 4, a set-top box (STB) 30 connected to the Internet, a digital television (DTV) connected to the set-top box 30 by the digital network and a digital VCR 32 are mutually connected.

The set-top box 20 includes a Web server FCM proxy which provides an Internet Web service to the Internet and having a proxy server function of other appliances connected to a digital network, that is, for example, a HAVi network, a message processing protocol layer for transmitting and receiving a Web document in a message format through the digital network, a TCP/IP protocol layer for processing the Web document to be transmitted and received through the Internet, and an Internet interface protocol layer connected to the Internet, for processing the Web document to be transmitted and received.

The digital television 31 includes a Web server FCM for providing a Web document to the Internet, and a message processing protocol layer for processing the Web document in a message format.

The digital VCR 32, like the digital television 31, includes a message processing protocol layer for processing the Web document in a message format to the Internet.

As depicted, the set-top box among the appliances which are connected to the digital network additionally includes a protocol layer such as the TCP/IP or a PPP by which the Internet connection device and the Internet can be connected, while, other digital television or the digital VCR merely has the Web server FCM.

The Web server FCM is an HTTP protocol and provides a Web document to the Internet.

As depicted, in the set-top box 30, the Web server FCM proxy is implemented to transmit a Web service request received through the Internet to a corresponding appliance and transmits a Web service response received from the corresponding appliance to the Internet. Further, the appliances 31 and 32 implemented the Web sever FCM provide Web services to the Web server FCM proxy in response to the Web service requests from the Web server FCM proxy.

Accordingly, the electronic home appliances connected through the digital network can be connected to an appliance such as the digital VCR installed in the home from a working place which is remote from the home and controlled for a reservation recording.

As so far described, according to the system and method for providing an Internet service in a non-IP based network, when the Internet server proxy connected to the Internet receives an Internet service request from the Internet and transmits the Internet service request to a corresponding Internet service server connected as being distributed in the digital network, the Internet service server provides the Internet service to the Internet through the Internet server proxy, so that the appliances can be controlled through the Internet.

In addition, since the Internet service servers connected through the digital network and the Internet service server proxy connected to the Internet have the same protocol layer, so that the type of the service and information can be shared by them and its application program can be easily fabricated.

Moreover, since only the Internet service server proxy connected to the Internet among the Internet service servers connected through the digital network has the IP address, and the remaining Internet service servers provide only the Internet service, it is easy to assign the IP address and operate it.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A system for providing an Internet service in a non-IP based network, comprising:
a first server connected to a non-IP based network and having an application program as installed; and
a second server connected to a non-IP based network and an IP based network (the Internet) and having the application program as installed, so that a service corresponding to an Internet service request is provided to the Internet according to the Internet service request received from the Internet.

2. The system of claim 1, wherein the non-IP based network is a digital network such as a HAVi (Home Audio/Video interoperability).

3. The system of claim 1, wherein the Internet service is transmitted in a digital format or a Web document format.

4. The system of claim 1, wherein the Internet service is accessed from the Internet to the first and the second servers to control the first and the second servers.

5. The system of claim 1, wherein the first server comprises:
a data processing protocol layer for transmitting and receiving a data to and from the non-IP based network; and
an application program layer for providing an Internet service.

6. The system of claim 5, wherein the data is a digital format or a message format.

7. The system of claim 5, wherein the application program layer processes a Web document.

8. The system of claim 1, wherein the second server comprises:
a data processing protocol layer for transmitting and receiving a data to and from the non-IP based network;
a TCP/IP protocol layer for processing the data to be transmitted and received to and from the non-IP based network;
an interface layer for transmitting and receiving the data processed at the TCP/IP protocol layer to and from the non-IP based network; and
an application program layer for connecting the first server which provides an Internet service and is connected to the non-IP based network, to the IP based network.

9. The system of claim 1, wherein the second server is connected to a plurality of first servers to serve as a proxy.

10. A method for providing an Internet service in a non-IP based network, comprising:
a step in which a non-IP based network receives an Internet service request from the Internet; and
a step in which the non-IP based network provides the Internet service corresponding to the received Internet service request to the Internet.

11. The method of claim 9, wherein in the step of receiving the Internet service request from the Internet, comprises
a step in which the second server positioned between the Internet and the non-IP based network determines whether the requested Internet service is a service to be provided by itself;
a step in which when the server determines that the requested Internet service is a service to be provided by itself, the server provides its own service to the Internet, while, otherwise, the server transmits an Internet service start signal to the first server connected to the non-IP based network; and
a step in which the Internet service is received from the first server.

12. A system for providing an Internet service in a non-IP based network, comprising:
a first appliance for controlling and communicating the non-IP based network with the internet; and
a second appliance which is connected with the first appliance for providing the internet service to an appliance connected with the internet via the first appliance when the internet service is requested by the appliance connected to the Internet via the first appliance.

13. The system according to claim 12, wherein the first appliance functions a proxy server for controlling and communicating between the appliance connected with the internet and the second appliance.

14. The system according to claim 12, wherein the second appliance functions a server for providing its own information.

15. The system according to claim 12, wherein the non-IP based network is capable of connecting a plurality of appliances functioned as the second appliance.

16. The system according to claim 15, wherein the function of the first appliance is changed to one of the plurality of appliances and the second appliance.
